(19) United States
(12) Patent Application Publication
(10) Pub. No.: US 2005/0108445 A1
(43) Pub. Date: May 19, 2005

(54) Systems and methods for implementing device regionalization

(76) Inventor: Michael A. Lassner, Vancouver, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/700,126

(22) Filed: Nov. 3, 2003

(51) Int. Cl. G06F 3/00

(52) U.S. Cl. 710/16

(57) ABSTRACT

Disclosed are systems and methods implementing device regionalization. In one embodiment, a system and a method pertain to identifying a region code, establishing a region for a device relative to the identified region code, and presenting information to a device user about components that can be used with the device relative to the established region.

### BACKGROUND

Manufacturers of peripheral devices such as printers, copiers, facsimile machines, multi-function peripheral (MFP) devices, and digital senders occasionally geographically regionalize their devices so they can maintain control over the prices for components that are available for use with those devices in relation to the location in which the devices are sold and used. For instance, such manufacturers may wish to lower the cost of device components, such as replacement parts, in certain areas of the world to ensure that customers in those areas can afford such components, as well as to maintain the price point for the components in areas in which the market price for such components is higher.

With markets for such devices and their components becoming more and more global, device manufacturers may wish to implement measures to prevent undermining of such regionalization. For instance, a manufacturer may wish to take measures to prevent the creation of so-called gray markets for device components through which vendors can circumvent the regionalization plan by reselling lower cost components obtained from one geographical region (e.g., a developing nation) in another geographical region (e.g., a leading economic country).

There are several challenges to implementing and preserving such a regionalization plan. For one, it is desirable to establish the region for a given device late in the distribution chain. Without such late region establishment, the region must be established early (e.g., during production), thereby limiting the distribution options for the manufacturer in terms of which devices may be distributed to which geographical areas of the world. Furthermore, a mechanism must be provided for indicating to the end user which components are available for the device after its region has been established.

### SUMMARY

Disclosed are systems and methods for implementing device regionalization. In one embodiment, a system and a method pertain to identifying a region code, establishing a region for a device relative to the identified region code, and presenting information to a device user about components that are available for use with the device relative to the established region.

### BRIEF DESCRIPTION OF THE DRAWINGS

The disclosed systems and methods can be better understood with reference to the following drawings. The components in the drawings are not necessarily to scale.

FIG. 1 is a schematic view of an embodiment of a system with which device regionalization can be implemented.

FIG. 2 is a block diagram of an embodiment of a user computer shown in FIG. 1.

FIG. 3 is a block diagram of an embodiment of a peripheral device shown in FIG. 1.

FIG. 4 is a flow diagram that illustrates an embodiment of a method for implementing device regionalization.

FIG. 5 is a flow diagram that illustrates an embodiment of operation of a region identification system of the peripheral device of FIG. 3.

FIG. 6 is a flow diagram that illustrates an embodiment of operation of a device driver of the user computer of FIG. 2.

### DETAILED DESCRIPTION

As described above, there are several challenges to implementing and preserving device regionalization including, for example, establishing the region for the device late in the distribution chain and providing a mechanism for indicating to the end user which components are available for use with the device after its region has been established. As is discussed below, however, such regionalization can be implemented by providing a device that establishes its region by reading a region code from a device component, and a driver that obtains the region code from the device and then identifies to the user the components that are available for the device.

Disclosed herein are embodiments of systems and methods for implementing device regionalization. Although particular embodiments are disclosed, these embodiments are provided for purposes of example only to facilitate description of the disclosed systems and methods.

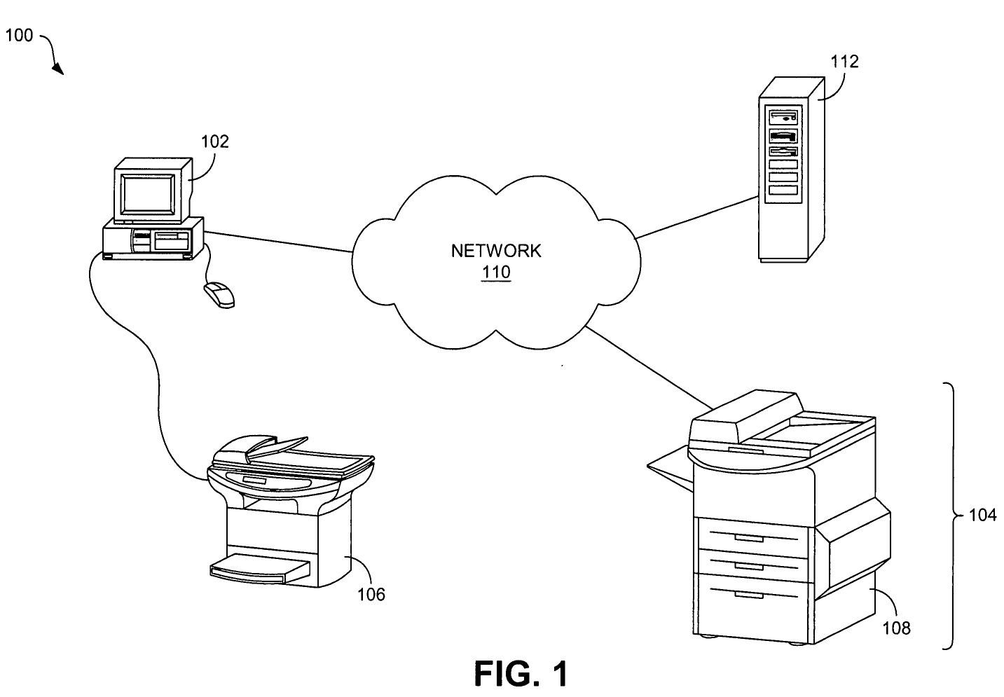

Referring now in more detail to the drawings, in which like numerals indicate corresponding parts throughout the several views, FIG. 1 illustrates an example system 100. As indicated in that figure, the system 100 generally comprises a user computer 102 and one or more peripheral devices 104. In the embodiment of FIG. 1, the user computer 102 comprises a desktop personal computer (PC) that is configured to communicate with and control the devices 104. Although a PC is illustrated in FIG. 1 and has been explicitly identified herein, the user computer 102 could comprise a different type of computer, such as a notebook computer or a MacIntosh™ type computer. More generally, the user computer 102 comprises any computing device that can communicate with the devices 104, for instance by sending data to the devices.

The peripheral devices 104 comprise the devices that are to be regionalized such that only certain components designated for a given region may be used with the devices. In the embodiment shown in FIG. 1, the peripheral devices 104 comprise printing devices including a multi-function peripheral (MFP) device 106 that is directly connected to the user computer 102 and a printer 108 that is indirectly connected to the user computer via a network 110. Although the devices 104 are designated as “peripheral” devices, these devices may further be available for walk-up use (e.g., to scan or copy documents).

The network 110 may comprise a single network, such as a local area network (LAN), or may comprise a collection of networks (LANs and/or wide area networks (WANs)) that are communicatively coupled to each other. In some embodiments, the network 110 may comprise part of the Internet.

Also included in the embodiment of FIG. 1 is a server 112 that can be accessed via the network 110. This server 112 may be generally accessible via the Internet. In such a case, the server 112 may comprise a web server that is, for instance, supported by or on the behalf of the manufacturer(s) of the devices 104.

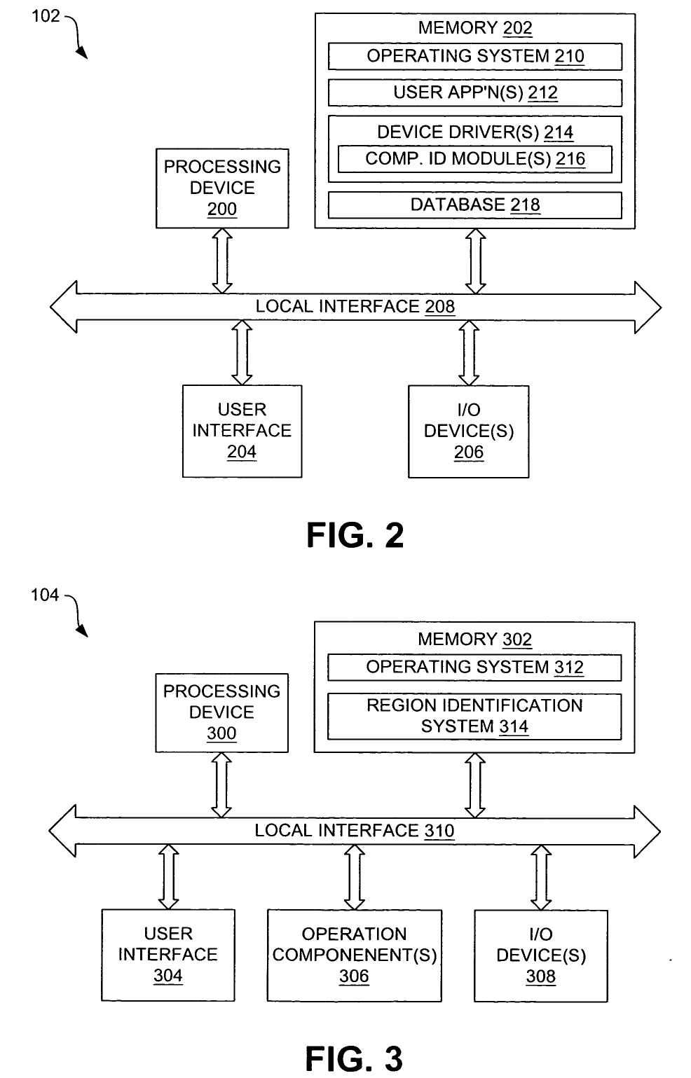

FIG. 2 is a block diagram illustrating an example architecture for the user computer 102 shown in FIG. 1. As indicated in FIG. 2, the user computer 102 comprises a processing device 200, memory 202, a user interface 204, and at least one input/output (I/O) device 206, each of which is connected to a local interface 208.

The processing device 200 can include a central processing unit (CPU) or an auxiliary processor among several processors associated with the user computer 102, or a semiconductor based microprocessor (in the form of a microchip). The memory 202, includes any one of or a combination of volatile memory elements (e.g., RAM) and nonvolatile memory elements (e.g., hard disk, read only memory (ROM), tape, etc.).

The user interface 204 comprises the components with which a user interacts with the user computer 102. The user interface 204 may comprise, for example, a keyboard, mouse, and a display, such as a cathode ray tube (CRT) or liquid crystal display (LCD) monitor. The one or more I/O devices 206 are adapted to facilitate communications with other devices and may include one or more of a universal serial bus (USB), a Firewire, or a small computer system interface (SCSI) connection component, as well as one of more communication components such as a modulator/demodulator (e.g., modem), wireless (e.g., radio frequency (RF)) transceiver, network card, etc.

The memory 202 comprises various programs including an operating system (O/S) 210, one or more user applications 212, and at least one device driver 214. The O/S 210 controls the execution of other programs and provides scheduling, input-output control, file and data management, memory management, and communication control and related services. The user applications 212 include any programs that the user may use to generate or modify data for provision to the peripheral devices 104. For instance, the user applications 212 may be used to generate print data for the peripheral devices 104 that may be used to generate hard copy documents. The device drivers 214 comprise programs that are used to control and operate the peripheral devices 104 from the user computer 102. More specifically, the device drivers 214 comprise code that acts in the capacity of a translator between a host program (e.g., a user application 212) and the peripheral devices 104.

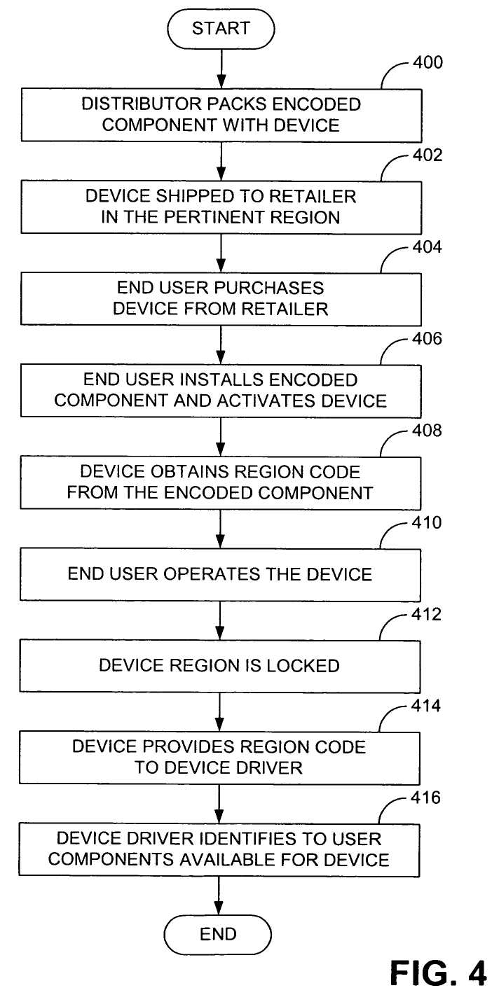

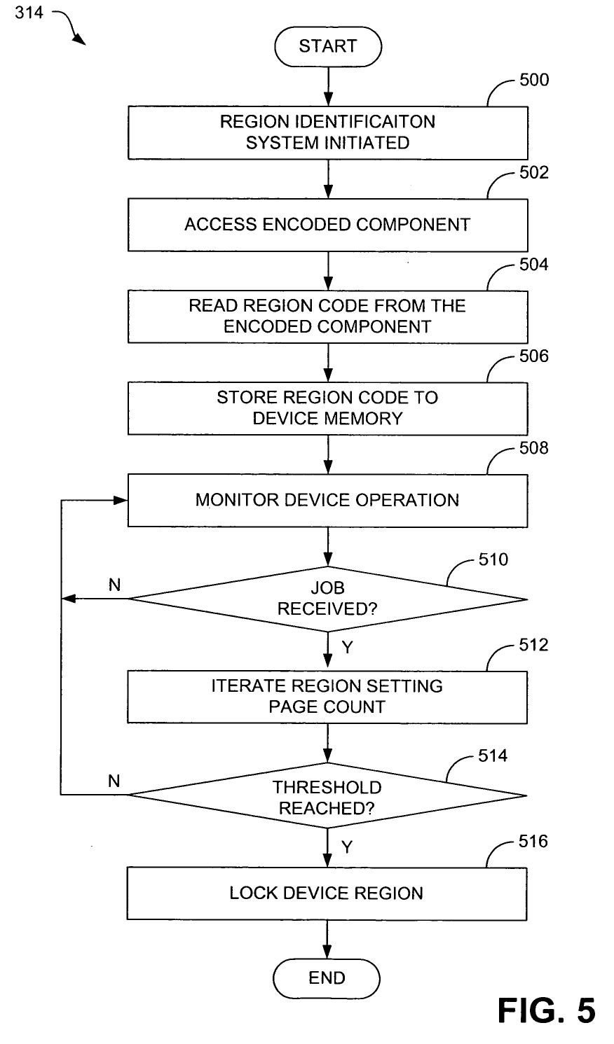

As indicated in FIG. 2, each device driver 214 includes a component identification module 216 that is used to identify a region to which a given peripheral device 104 is assigned or associated, and further identify device components to the user that are available for the user's device in that region. Operation of the device drivers 214, and the component identification modules 216 in particular, is described in relation to FIGS. 4 and 5.

In addition to the above-described programs, the memory 202 may include a database 218 that contains various information pertinent to components available for a given peripheral device 104 relative to the region to which the device has been assigned. The database 218 may be separate from, but accessible to the device driver 214.

FIG. 3 is a block diagram illustrating an example architecture for a peripheral device 104 shown in FIG. 1. As indicated in FIG. 3, the peripheral device 104 comprises a processing device 300, memory 302, a user interface 304, at least one device operation component 306, and at least one I/O device 308. Each of those components is connected to a local interface 310.

The processing device 300 is adapted to execute commands stored in memory 302 and can comprise a general-purpose processor, a microprocessor, one or more application-specific integrated circuits (ASICs), a plurality of suitably configured digital logic gates, and other well known electrical configurations comprised of discrete elements both individually and in various combinations to coordinate the overall operation of the peripheral device 104. The memory 302 comprises any one or a combination of volatile memory elements (e.g., random access memory (RAM)) and nonvolatile memory elements (e.g., read-only memory (ROM), Flash memory, hard disk, etc.).

The user interface 304 comprises the tools with which the device settings can be changed and through which the user can directly communicate commands to the peripheral device 104. By way of example, the user interface 304 comprises one or more function keys contained within a device control panel. Such a control panel may further include a display, such as a liquid crystal display (LCD) or light emitting diode (LED) display.

The one or more device operation components 306 include a component that is configured to perform a given function that pertains to device operation. For instance, in situations in which the peripheral device 104 comprises a printing device, such a component 306 may comprise a print cartridge that is adapted for laser or ink printing. As is described in greater detail below, at least one of the device operation components 306 is encoded with a region code such that the peripheral device 104 can obtain the region code from the encoded component to establish a region for the device. Any one of the operation components 306 may be so encoded. Typically, however, such components 306 are removable from the peripheral device 104 such that they can be easily installed within the device by the end user.

The one or more I/O devices 308 facilitate communications with other devices and, like the I/O devices 206, may comprise one or more of a USB, a Firewire, or a SCSI connection component, as well as one or more network communication devices such as a modulator/demodulator (e.g., modem), network card, wireless (e.g., RF) transceiver, or other such communication component.

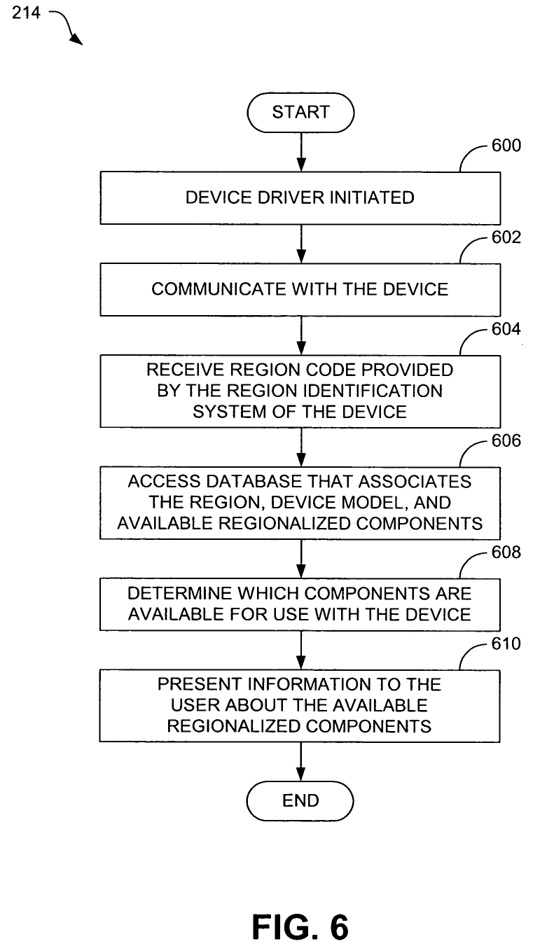

The memory 302 includes various programs including an O/S 312 and a region identification system 314 that, as is described below, comprises logic that is configured to determine the region to which the device is to be assigned and to convey the determined region to the driver 214 of the user computer 102. Operation of the region identification system 314 is discussed in greater detail in relation to FIGS. 4 and 6 below.

Various programs (i.e. logic) have been described herein. These programs can be stored on any computer-readable medium for use by or in connection with any computer-related system or method. In the context of this document, a computer-readable medium is an electronic, magnetic, optical, or other physical device or means that contains or stores a computer program for use by or in connection with a computer-related system or method. These programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

Example systems having been described above, operation of the systems will now be discussed. In the discussions that follow, flow diagrams are provided. Process steps or blocks in these flow diagrams may represent modules, segments, or portions of code that include one or more executable instructions for implementing specific logical functions or steps in the process. Although particular example process steps are described, alternative implementations are feasible. Moreover, steps may be executed out of order from that shown or discussed, including substantially concurrently or in reverse order, depending on the functionality involved.

FIG. 4 provides an example of device regionalization. More particularly, FIG. 4 describes an example scenario in which device regionalization is implemented and preserved using aspects of the system 100 shown in FIG. 1. Beginning with block 400 of FIG. 4, a distributor, for example located at a distribution center operated by or on the behalf of a device manufacturer, packs an encoded component with a device to be regionalized, such as a peripheral device 104 (FIG. 1). The encoded component comprises a device component that can be installed into the device, for instance by the end user, prior to device operation. The component therefore may comprise a removable (e.g., disposable) component that, for instance, is replaced once its usable life has expired. By way of example, in a case in which the device is a printing device, the encoded component can comprise a print cartridge that includes the various elements that supply a printing medium (e.g., dry toner or ink) to the printing device. However, the encoded component can comprise substantially any device that can be installed in (or on) the device and which, as described below, can provide region information to the device.

As noted above in relation to FIG. 1, the encoded component is designated as being “encoded” in that it is modified so as to comprise information about a given region to which it, and the device in which it will be used, pertains. Accordingly, the encoded component comprises a region code that can be provided to the device once the component is installed. By way of example, encoding may be achieved by short-circuiting various conductor lines of the component to create a component signature that can be read by the device to convey the encoded region information. Shorting of such lines, while facilitating region identification, does not adversely affect component or device operation.

With reference next to block 402 of FIG. 4, the device is shipped, along with the packed encoded component, to a retailer in the pertinent region, i.e. the region for which the component is encoded. To cite a specific example, a distribution center of the device manufacturer may have an order from a retailer in China for a given device. The distribution center can then simply include a component encoded for China with the device, and then ship the device and component to the Chinese retailer.

Once the device is received by the retailer, the retailer can then offer it for sale and, as indicated in block 404, an end user can purchase the device. During the device assembly process, the user installs the encoded component in the device and may then activate the device, as indicated in block 406. If the encoded component comprises a print cartridge, the user can remove the cartridge from its packaging, insert the cartridge in the appropriate location within the device housing, and then power the device as instructed by an accompanying information card or user manual.

Once the device is activated, it obtains the region code from the encoded component, as indicated in block 408. This process may involve one or more communications between the region identification system 314 (FIG. 3) of the device and the encoded component (e.g., component 306) that, for instance, occur each time the device is turned on. At this point, the user may operate the device, as indicated in block 410. Either immediately or at some later time, the device then locks the region for the device, as indicated in block 412, relative to the region code obtained from the encoded component. Accordingly, the device region is then fixed such that only components for the region to which the device has been locked can be used with the device and use of any other component will result in an error message.

Notably, the above-described processes accomplish various desired goals. For one, the device's region is established at the end of the distribution chain by simply providing an appropriate encoded component along with the device. Not only does such a procedure increase distribution flexibility by avoiding early designation of the device's region, but the procedure further allows for later redefining of the regions without requiring modification of the device. Moreover, regionalization is preserved once the device has been operated in that the device is locked to the given region. At that point, no gray market components can be used, thereby reducing demand for such components.

Referring next to block 414, the device at some point provides the region code obtained from the encoded component to a device driver that executes on a computer (e.g., user computer 102, FIG. 2). By way of example, the region code is so provided when the device driver communicates with the device when a print job is being or is about to be transmitted to the device. Optionally, the device driver 214 may store the region code for later reference. At this point, the device driver can identify to the user the components that are available for the device, as indicated in block 416. This information can be automatically provided to the user soon after the region code is provided to the device driver, upon user request, and/or when the driver determines (e.g., from a communication with the device) that a given device component needs to be replaced or repaired.

The information provided to the user can be obtained by the device driver from, for example, a database stored on the user computer that cross-references region codes with device models. With the information identified by the driver, the user can obtain any part or order numbers required to order a given device component. Given that the order numbers are particular to the region for which the device is locked, the order numbers enable the user to purchase the correct, regionalized components for their devices, and ensure that those components are priced as desired by the manufacturer.

FIG. 5 provides an example of operation of the region identification system 314 of the peripheral device 104 (FIG. 3) in collecting, locking, and providing a region code in the manner described above in relation to FIG. 4. Beginning with block 500, the region identification system 314 is initiated. This initiation may occur, for example, upon powering of the peripheral device 104 or upon detection of a communication from a host device (e.g., user computer 102). Regardless, once the region identification system 314 is initiated, the system accesses the encoded component, as indicated in block 502. As described above, the encoded component may have been encoded by short-circuiting certain conductor lines of the component. In such a case, the encoded component will have a particular electrical signature that identifies the region for which the component has been encoded. Alternatively, the encoded component may comprise a memory module in which the region code (and possibly other data) is stored, and from which the code may be read.

Next, with reference to block 504, the region identification system 314 reads the region code from the encoded component, for example using one of the methods described above. The region code is then stored to device memory 302, as indicated in block 506, so as to retain the region code at least until such time when the region code is provided to the device driver with which the device interacts.

At this point, the region identification system 314 monitors device operation, as indicated in block 508. By way of example, the region identification system 314 determines whether a print job is received, as indicated in decision block 510. If not, flow returns to block 508 and the region identification system 314 continues the monitoring process. If, on the other hand, a print job is received, the region identification system 314 iterates a region setting page count, as indicated in block 512, for each page printed in association with the received print job.

With reference next to decision block 514, the region identification system 314 determines whether a threshold number of printed pages has been reached. If not, no further action is yet required and flow again returns to block 508. However, if the threshold is reached, flow continues to block 516 at which the region identification system 314 locks the device region. Such locking may comprise storing further data in association with the stored region code to indicate that the device is now permanently assigned to or associated with a particular region. By delaying locking until a given number of pages (e.g., 50) are printed, premature region locking, for instance during device manufacturing and/or testing, can be avoided. It is noted that, in alternative embodiments, other criteria may be used to determine when to lock the device region. For example, locking could occur after the passage of a predetermined period of time (e.g., number of hours) that the device has been powered.

After the process described above has been completed, the device is permanently configured for use in a given region and, therefore, is configured for use with components that are likewise configured (i.e. encoded) for that region. To aid the user in locating components for the device, including replacement parts (e.g., a black print cartridge) and optional components (e.g., a color print cartridge), the user must be provided with information that identifies the appropriate components. This can be achieved by the region identification system 314 (FIG. 3) by providing the region code to the device driver that executes on the user's computer, and by the driver providing the required information to the user on the computer. FIG. 6 provides an example of a device driver 214 (FIG. 2), and a component identification module 216 of the driver in particular, in enabling such functionality.

Beginning with block 600 of FIG. 6, the device driver 214 is initiated. Such initiation may occur, for example, when a “print” command is entered in an appropriate program (e.g., user application 212, FIG. 2) that is executing on the user computer 102. Alternatively, initiation can occur when the device driver 214 is accessed using an appropriate access command (e.g., indicated by selection of a device icon). In either case, once the device driver 214 is initiated, the driver can communicate with the peripheral device 104, as indicated in block 602. Such a communication may comprise, for instance, part of an exchange between the device driver 214 and the peripheral device 104 that is necessary to transfer print data to the peripheral device during a printing session.

Through the communication (block 602), the device driver 214, and therefore the component identification module 216, receives a region code provided by the region identification system 314 of the peripheral device 104, as indicated in block 604. At this point, the component identification module 216 may access a database that associates region codes, device models, and available regionalized device components, as indicated in block 606. Notably, the component identification module 216 inherently “knows” the device model in that the driver 214 is designed for and has already communicated with the peripheral device 104. By way of example, the database comprises a local database, such as database 218 shown in FIG. 2, which is separate from but accessible to the device driver 214. Such an arrangement permits the database to be updated without requiring modification of the driver 214. That functionality may be particularly desirable in cases in which modification of the driver 214 would require the driver developer to re-certify the driver. As is known in the relevant art, the certification process required by some operating system developers is especially stringent and therefore may require extensive work on the part of the driver developer to get the modified driver certified and/or may delay distribution of the modified driver. In an alternative arrangement, the database may comprise a remote database, for instance stored on the server 112 and accessed over the network 110.

By accessing the database, the component identification module 216 can determine which components are available for use with the peripheral device 104, as indicated in block 608. For instance, as to any given model device, there may be several different available components. Of those, however, only components associated with the identified region are to be identified to the user. Accordingly, only those components are “selected” from the database for presentation.

With reference next to block 610, the component identification module 216 presents information to the user about the available regionalized components. As described above in relation to FIG. 4, this information can be provided soon after the region code is obtained by the device driver 214, upon request by the user (e.g., entered by the user in a user interface for the device driver), or upon a determination that a given device component requires replacement (e.g., is empty). The component information comprises one or more part or order numbers that the user can use to obtain the correct components for his or her now regionalized device. These numbers are provided to the user with, for example, a pop-up dialog box that provides instructions in the language that is appropriate for the region in which the device is being used (i.e. the same language used in the driver user interface). Optionally, the information can comprise one or more hyperlinks to providers on the Internet that sell the pertinent regionalized components. In such a case, the user can order a desired component by providing the part or order number to the provider, or selecting the part or order number from a list presented by the provider (e.g., on a web site).

1. A method for implementing device regionalization, comprising:
identifying a region code;
establishing a region for a device relative to the identified region code; and
presenting information to a device user about components that can be used with the device relative to the established region.

2. The method of claim 1, wherein identifying a region code comprises reading a region code embedded into a device component.

3. The method of claim 1, wherein identifying a region code comprises reading a region code embedded into a print cartridge that is installed within the device.

4. The method of claim 1, wherein establishing a region comprises storing the identified region code in device memory.

5. The method of claim 4, wherein establishing a region further comprises locking the region code for the device.

6. The method of claim 4, wherein locking the region code comprises determining the number of pages that have been printed by the device and locking the region code if the number of pages reaches a predetermined threshold.

7. The method of claim 1, wherein presenting information comprises providing the region code to a user computer.

8. The method of claim 7, wherein presenting information further comprises accessing a database that cross-references the region code with components available for the device so as to limit presentation to information concerning components intended for use in the established region.

9. The method of claim 1, wherein providing the region code comprises providing the region code to a device driver that executes on the user computer and wherein accessing a database comprises accessing the database with the device driver.

10. A system for implementing device regionalization, comprising:
means for reading a region code embedded within a device component;
means for providing the region code to a user computer; and
means for presenting component information to a device user on the user computer that identifies components that are available for the device in a region indicated by the region code.

11. The system of claim 10, wherein the means for reading a region code comprise means for reading a region code from a device component when the component is installed in the device.

12. The system of claim 10, wherein the means for providing the region code comprise means for providing the region code to a device driver that executes on the user computer.

13. The system of claim 10, wherein the means for presenting component information comprise means for accessing a database that cross-references the region code with components available for the device so as to limit presentation of information to information concerning components intended for use in the established region.

14. The system of claim 10, further comprising means for locking a region code for the device.

15. The system of claim 14, wherein the means for locking the region code comprise means for determining the number of pages that have been printed and comparing that number with a predetermined threshold.

16. A system stored on a computer readable medium, comprising:
logic for reading a region code from a device component installed in a device;
logic configured to store the read region code;
logic configured to provide the stored region code to a device driver that executes on a user computer; and
logic configured to determine components that are available for use with the device in relation to the region code.

17. The system of claim 16, wherein the logic configured to store is further configured to lock the region code on the device.

18. The system of claim 16, wherein the logic configured to store is configured to lock the region code after a predetermined number of pages have been printed by the device.

19. The system of claim 16, wherein logic configured to provide the region code is configured to provide the region code to the device driver when the device driver communicates with the device to send the device a print job.

20. The system of claim 16, wherein the logic configured to determine components is configured to identify the components from a database using the region code and a device model.

21. A region identification system stored on a computer-readable medium, the system comprising:
logic configured to read a region code from an encoded component installed within a device;
logic configured to store the read region code; and
logic configured to provide the stored region code to a device driver that executes on a user computer.

22. The system of claim 21, further comprising logic configured to lock the region code for the device after a predetermined criterion is satisfied.

23. The system of claim 22, wherein the logic configured to lock the region code is configured to lock the region code after a predetermined number of pages have been printed by the device.

24. A device, comprising:
a processing device; and
memory including a region identification system that is configured to read a region code from an encoded component installed within a device, store the read region code, and provide the stored region code to a device driver that executes on a user computer.

25. The device of claim 24, wherein the region identification system is further configured to lock the region code for the device after a predetermined criterion is satisfied.

26. The device of claim 25, wherein the region identification system is configured to lock the region code after a predetermined number of pages have been printed by the device.

27. A device driver stored on a computer-readable medium, the driver comprising:
a component identification module that is configured to receive a region code from a device that is controlled by the device driver, access a database using the region code and a device model to determine the components that are available for the device in a region represented by the region code, and identify the determined components to a device user.

28. The device driver of claim 27, wherein the component identification module is configured to identify a part or order number to the device user.
